(19) United States
(12) Patent Application Publication
(10) Pub. No.: US 2003/0041312 A1
(43) Pub. Date: Feb. 27, 2003

(54) Program processing method utilizing dynamically reconfigurable hardware to enable faster processing, and program to execute same processing method

(75) Inventor: Syunsuke Fueki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/272,005

(22) Filed: Oct. 17, 2002

Related U.S. Application Data
(63) Continuation of application No. PCT/JP00/03378, filed on May 25, 2000.

(51) Int. Cl. G06F 9/44

(52) U.S. Cl. 717/100

(57) ABSTRACT

A program processing method, in an evaluation process, analyzes a source program (PB), computes usage cost values of the resources of the computer, in units of prescribed program modules comprised by the source program, and selects a program module (M,N) for which the usage cost value is high; in an editing process, generates a hardware module object (OBm,OBn) which configures dynamically reconfigurable hardware into a configuration for processing of the selected program module; in an execution process, executes the modified source program by means of hardware configured according to the hardware module object and the computer. According to the method, the optimal program module for replacement by dynamically reconfigurable hardware is selected. Hence by replacing the selected program module with hardware, a minimal amount of dynamically reconfigurable hardware can be used to maximize the execution efficiency of the source program.

### TECHNICAL FIELD

This invention relates to a program processing method to increase program execute speed, and recording media on which is recorded a program executing this processing method. More specifically, this invention relates to a program processing method which is able to modify a source program by analyzing and evaluating the source program to be executed by the computer and by executing a portion of the program code using dynamically reconfigurable hardware, and is able to appropriately interface with the hardware at the time of program execution, and also relates to recording media on which is recorded a program which causes a computer to execute the above processing method.

### BACKGROUND ART

The success of the computer industry in recent years has been due to a “downsizing” from mainframes to personal computers, with a consequent dramatic improvement in the processing power per unit cost. In essence, current processor architectures are methods for processing all algorithms written in a predetermined instruction language with a given instruction length, so that faster processing has been achieved solely by shortening execution cycles.

However, this method requires that the chip areas of recent processors, which require basic clock frequencies of hundreds of megahertz, be reduced, and so depends on the most advanced process technologies, and so has also led to dramatic increases in the time and costs required by development. Consequently a new computer paradigm has been sought, which does not depend entirely on process technologies to improve processing speeds.

The field of reconfigurable computing is emerging as one such possible paradigm. In reconfigurable computing, by providing circuit internals with a modifiable structure, the circuit structure can be freely modified in response to external signals, to create a high-speed processing system.

However, although the concept of reconfigurable computing has been proposed, it remains no more than a concept, and there have been no specific proposals of methods for its realization.

An object of this invention is to provide a program processing method to raise the speed of program execution, and recording media on which is recorded a program which executes this processing method.

A further object of this invention is to provide a method using dynamically reconfigurable hardware which enables the faster execution of a source program.

### DISCLOSURE OF THE INVENTION

A first aspect of the invention is a program processing method, characterized in having an evaluation process, which analyzes a source program to be executed by a computer, computes usage cost values of the resources of the above computer, in units of prescribed program modules comprised by the source program, and selects a program module for which the above usage cost value is high; an editing process, which generates a hardware module object which configures dynamically reconfigurable hardware into a configuration for processing of the above selected program module; and an execution process, which executes the above modified source program by means of hardware configured according to the above hardware module object and the above computer.

According to this first aspect, by computing the usage cost values of a plurality of program modules comprised by the source program, the optimal program module for replacement by dynamically reconfigurable hardware can be selected. Hence by replacing the selected program module with hardware, a minimal amount of dynamically reconfigurable hardware can be used to maximize the execution efficiency of the source program.

In a preferred embodiment of the above first aspect, the above evaluation process has a new function synthesis processing process which, when the above source program has a global variable, generates a local variable corresponding to the above global variable, and replaces the global variable in the above source program with the local variable; further, the source program generated in the above new function synthesis processing is analyzed, and the usage cost value is computed.

### BRIEF DESCRIPTION OF THE DRAWINGS

FIG. 1 shows the overall configuration and processes of a program processing method of this aspect;

FIG. 2 is a flowchart showing the processing procedure of the translator;

FIG. 3 is a flowchart showing the processing procedure of the scheduler 4;

FIG. 4 is a flowchart showing the procedure for evaluation of the source program;

FIG. 5 is a flowchart showing the procedure for new function synthesis processing;

FIG. 6 shows in summary the manner in which the source program is modified and rewritten according to processing by the translator and scheduler;

FIG. 7 shows a first example of a source program;

FIG. 8 shows a second example of a source program;

FIG. 9 shows the second example of a source program;

FIG. 10 shows an example of a variable memory table;

FIG. 11 shows an example of a cost table;

FIG. 12 shows an interface to a normal function call and an interface to hardware;

FIG. 13 shows a diagram of the configuration of a computer system having an LSI device as reconfigurable hardware;

FIG. 14 shows an example of hardware configured using reconfigurable hardware.

### BEST MODE FOR CARRYING OUT THE INVENTION

Below, aspects of the invention are explained, referring to the drawings.

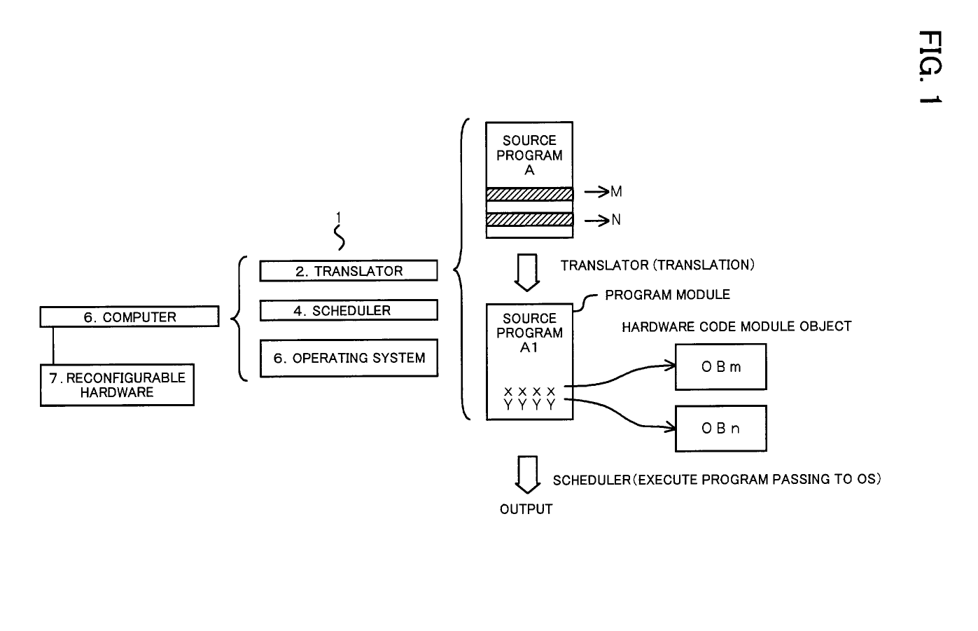

FIG. 1 shows the overall configuration and processes of a program processing method of this aspect. On the left side of FIG. 1, the system configuration implementing this program processing method is shown. As software, an operating system OS, and a translator 2 and scheduler 4 as middleware to implement the program processing method, are installed in a personal computer, workstation, or other computer 6. The computer 6 has the normal hardware, such as a CPU, main memory device, and external storage device (hard disk). In addition, a dynamically reconfigurable LSI device, connected via a bus to the CPU and main memory, is installed as reconfigurable hardware 7 in the computer 6.

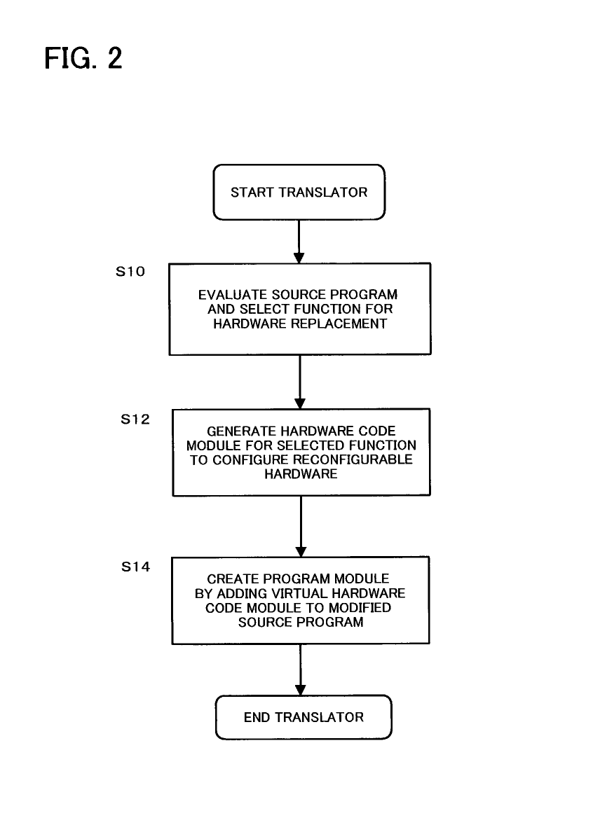

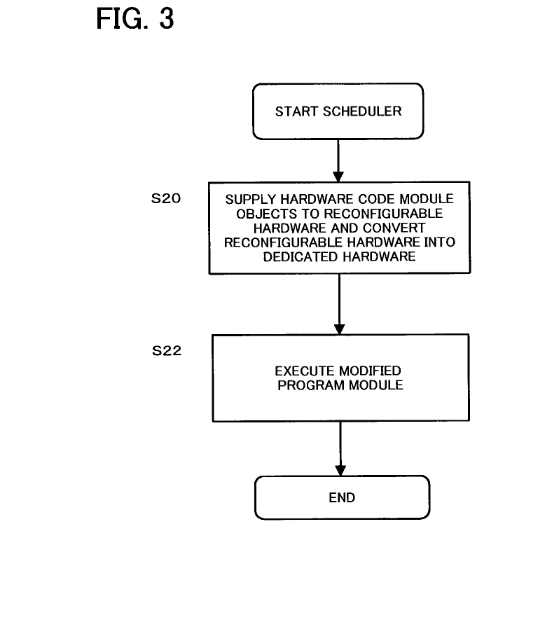

FIG. 2 is a flowchart showing the processing procedure of the above translator. FIG. 3 is a flowchart showing the processing procedure of the above scheduler 4. The translator 2 of this aspect analyzes the source program A which is to be executed by the computer, and for each program module comprised thereby, performs an evaluation by computing the usage cost of computer resources, to detect which program modules, when processed as software, have an adverse effect on high-speed operation (S10). In FIG. 1, the program modules of the shaded portions of the source program A (normally prescribed functions) are detected as being the major factors impeding high-speed processing.

The translator 2 can remove the program modules M, N from the source program A, enabling the detected program modules to be replaced with dedicated operation circuits in the reconfigurable hardware 7, as indicated in the process S12, and can in its place add pseudo-functions to the source program as call functions. Further, the extracted program modules M, N are replaced with binary code OBm, OBn to configure the reconfigurable hardware 7 into a configuration to execute processing corresponding to the modules M, N. In this aspect, the binary code is called a hardware code module object. As a result of this conversion operation, the original source program A is converted into a modified source program A1 comprising a pseudo-function, as well as hardware code module objects OBm, OBn.

The translator 2 further generates a virtual hardware code module at the time the pseudo-function in the modified source program A1 is called, in order to establish an interface within the address space, as shown in the process S14. The virtual hardware code module used to secure this interface is described in detail below. The translator 2 then adds this virtual hardware code module to the modified source program A1.

The scheduler 4 then loads the hardware code module objects OBm, OBn into the LSI device of the reconfigurable hardware LSI device, and configures dedicated hardware to perform processing of the program modules M, N (S20). Also, processing of the modified source program A1 is performed according to the normal application program execution procedure (S22). As a result, program modules which had had an adverse effect on high-speed processing in the original program A are simply replaced by pseudo-function calls in the modified source program A1, and are processed by dedicated hardware, so that execution efficiency is greatly improved.

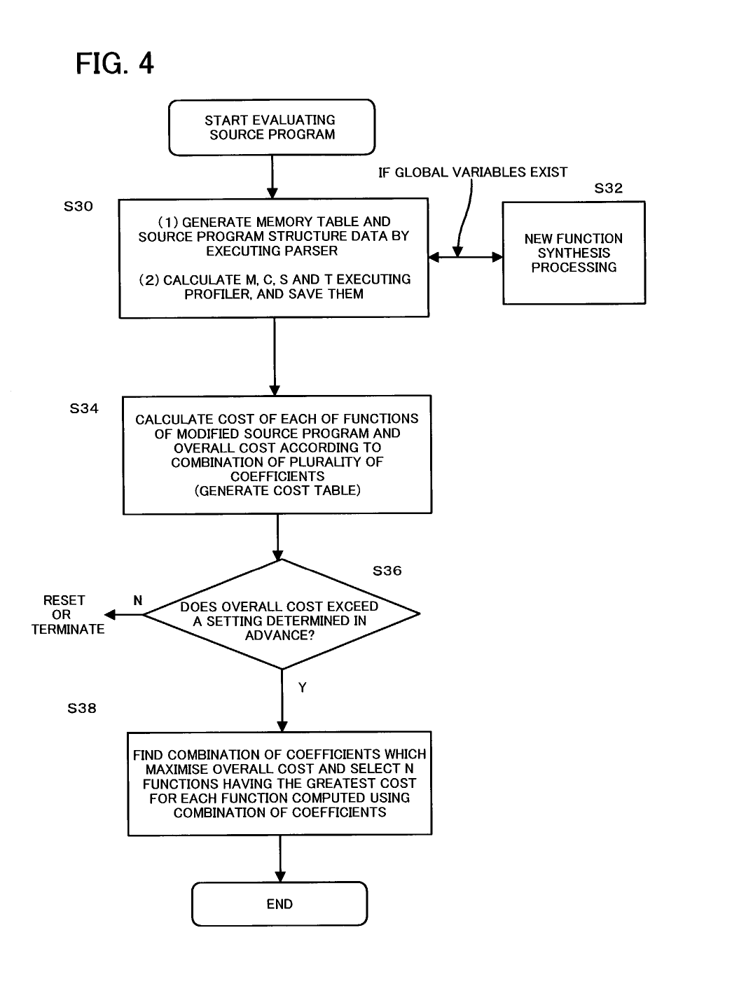

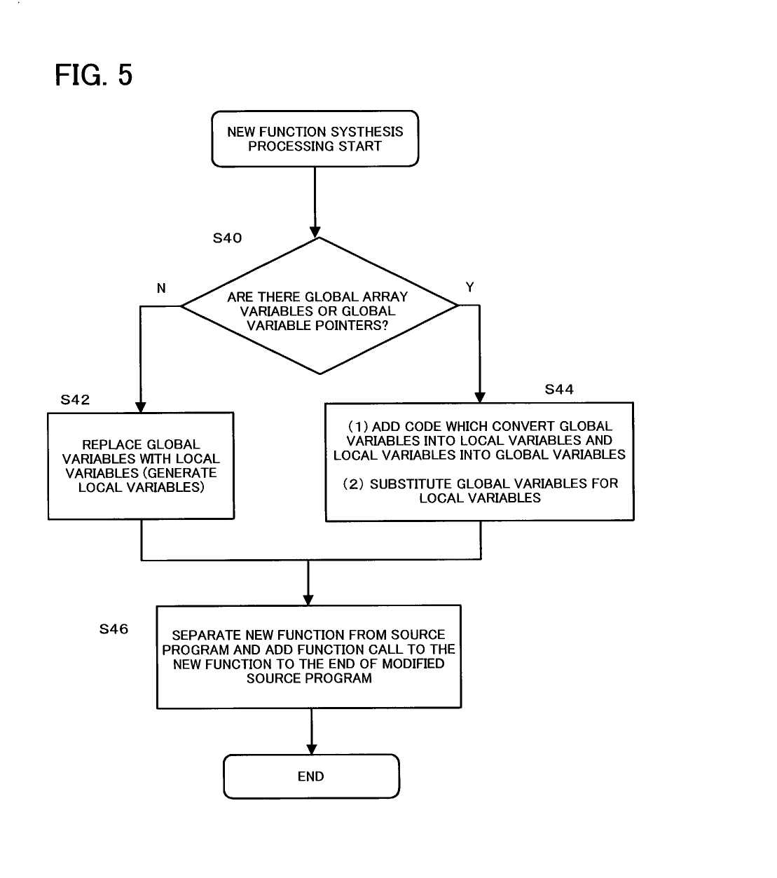

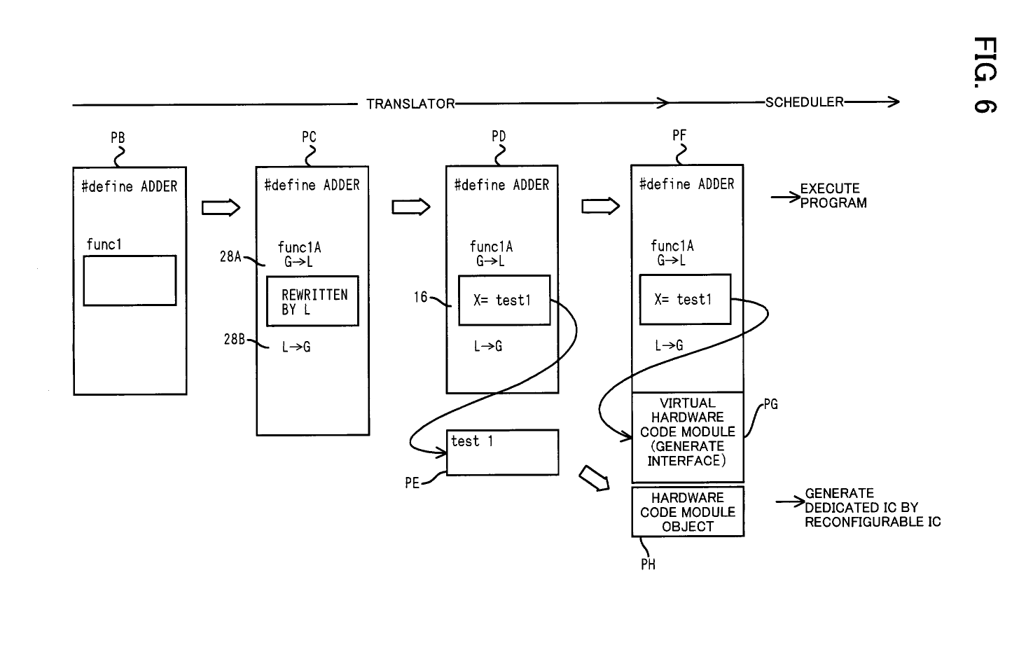

Having explained the overall system configuration and processes in the above, here an aspect of program processing is explained, for specific source program examples. FIG. 4 is a flowchart showing the procedure for evaluation of the source program in the process S10 of the translator. FIG. 5 is a flowchart showing the procedure for new function synthesis processing to modify the source program, performed as part of the evaluation procedure. And, FIG. 6 shows in summary the manner in which the source program is modified and rewritten according to processing by the translator and scheduler.

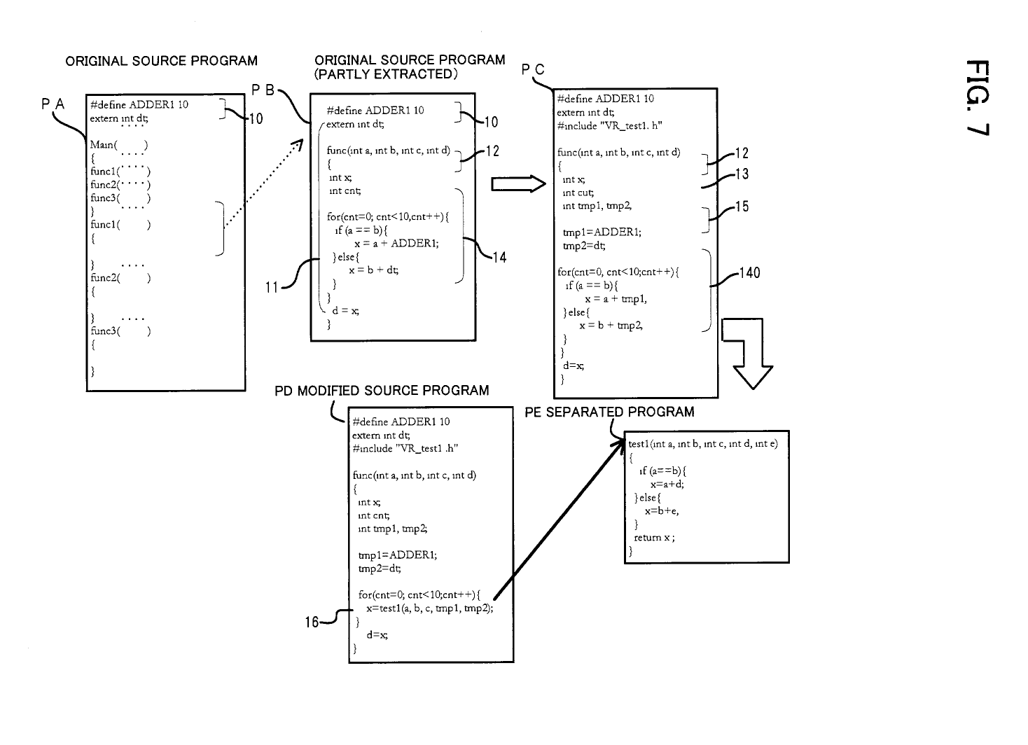

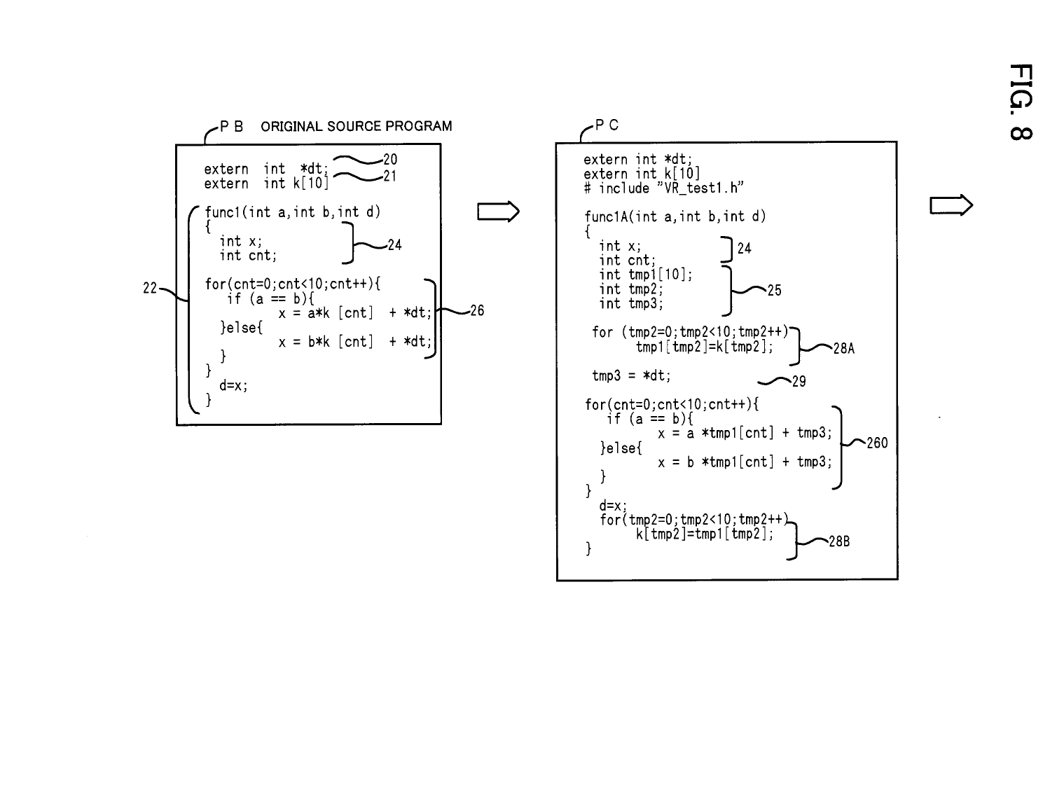

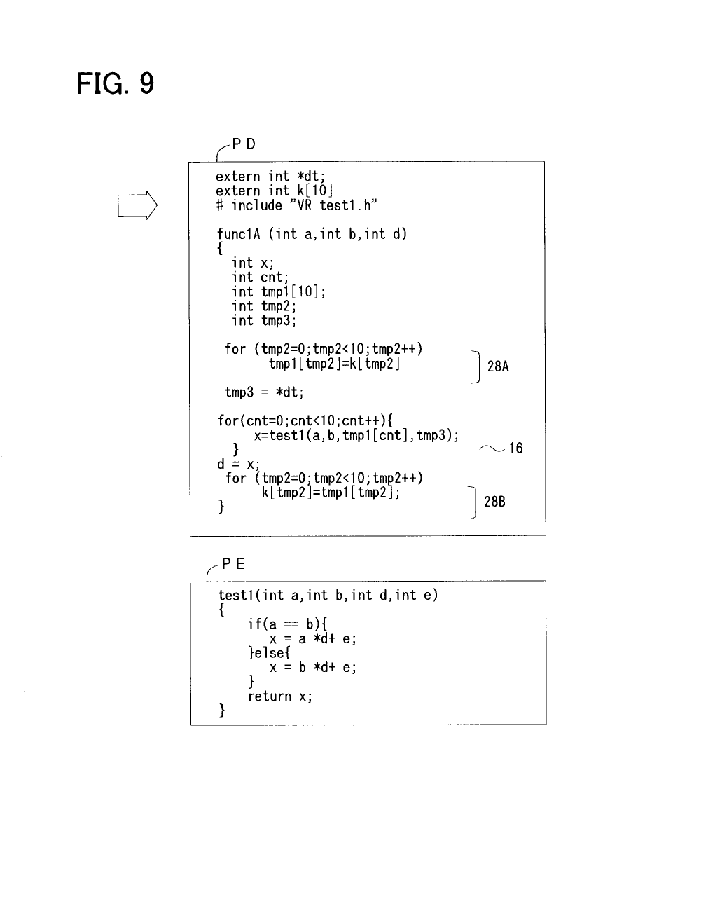

FIG. 7 shows a first example of a source program, while FIG. 8 and FIG. 9 show a second example of a source program. In all of these example, the source program is written in the C language as the programming language, and the manner in which the source program is modified by the processing program, comprising the translator 2 and scheduler 4 of this aspect, is illustrated.

The first example in FIG. 7 shows the original source program PB resulting from removal of a portion of the original source program PA. In the original source program PA, after the declaration of global variables 10, the processing procedure for three functions, func1 to func3, is described, and code for these functions appears. For simplicity, in the original source program PB only one of the functions is shown. In the original source program PB, first there is the declaration 10 of the global variables “ADDER1” and “dt”, and in the code for the function 11, there is a declaration 12 of the variables “x” and “cnt” as integers, and the processing code 14 for these appears. A global variable is a variable which is used by a plurality of functions, and is differentiated from local variables, which are used only within functions.

On the other hand, the second example of FIGS. 8 and 9 is the case in which the original source program PB has, as global variables, the address pointer-type global variable 20 and the global array variable 21. The “*dt” address pointer-type global variable 20 signifies the data stored at the address dt. The “k[10]” global array variable 21 signifies the data stored in the addresses 0 to 9. When such global variables are processed in the function 26, it is necessary that the result of operations within the function 26 be reflected in other functions as well. Hence in the case of such address pointer-type and array-type global variables, special considerations are necessary; this matter is discussed below.

The procedure for evaluation of the original source programs PA, PB is explained below, referring to FIGS. 4 and 5. The translator has a parser, which performs a syntax analysis of the source program, and a profiler, which detects processing states of the source program on the computer. As shown in the procedure S30, the parser performs syntax analysis of the source program written in the source code, and generates data in a prescribed tree structure, while also generating a variable memory table, which is a reference table for all variables within the source program. This variable memory table is discussed below, referring to an actual example. The profiler performs syntax analysis of the source program, and calculates the number of times C a function is called, and the processing time S required per time the function is called, as indices used to compute the cost of using computer resources. As other indices, the function memory usage amount M, and the number of levels T of the tree structure of a function, are also calculated.

However, the above indices are in units of functions which are prescribed program modules. In this case, when the original source program has global variables, a function which should be moved to reconfigurable hardware cannot simply be removed from the original source program. In other words, global variables which are used across a plurality of functions are modified by a function which is moved to reconfigurable hardware, and so it is necessary that such variables be coordinated.

Hence when the original source program PB has global variables, as in the first example of FIG. 7 and the second example of FIG. 8, the new function synthesis processing S32 is executed.

FIG. 5 is a flowchart showing the procedure of the new function synthesis processing. First, if by executing the parser it is judged that global variables exist in the original source program, the procedure for new function synthesis processing of FIG. 5 is executed. The above processing procedure differs depending on whether there exist global array variables or global variable pointers among the global variables.

As explained above, in the original source program PB of FIG. 7, there exist no global array variables or global variable pointers. Hence local variables corresponding to global variables are generated according to the procedure S42 shown in FIG. 5, and code in which global variables are replaced with local variables is added to the original source program PB. As a result, as shown in FIG. 7, code 13 in which the local variables tmp1, tmp2 are declared as integers, and code 15 in which the global variables ADDER1, dt and the local variables tmp1, tmp2 are substituted, are added, and the original function modified into a new function 140, as the source program PC. Hence by means of the procedure S42, the source program PC is generated.

Then, in procedure S46, the modified (new) function 140 is separated from the source program PC, and is added to the end of the modified source program PD. That is, within the source program PD, the code “x=test1(a,b,c,tmp1,tmp2)” (identified by the symbol 16 in the figure) which calls the function 140 is added, and the separated function 140 is added as a separated program PE. As a result of separating the function 140, the pseudo-function test1 is generated, and this pseudo-function test1 is called from the modified source program PD.

FIG. 6 shows in summary the original source programs PB, PC, PD. Focusing on the function func1 within the original source program PB, because there exists a global variable within the function, the conversion code “G→L” is added to convert the global variable G to the local variable L, so that a global variable [G] within fund is converted into a local variable L, and the source program PC is generated. As shown in the source program PD, a prescribed program module within the function func1A is separated as the function test1, the code “x=test1” calling this function is added, and the separated program module PE is added to the source program PD.

With the source program in the state PD, PE, the processing of the parser and profiler is executed through the procedure S30 described in FIG. 4, and a variable memory table, source program structure data, and indices for use in cost value computations are calculated.

The source program of FIGS. 8 and 9 is an example in which global array variables and global variable pointers exist. In this case, as shown in FIG. 5, the procedure S44 is executed in the new function synthesis processing. The original source program PB of FIG. 8 has a global array variable 21 and a global variable pointer 20. These global variables 20, 21 are declared as integers (symbol 24 in [FIG. 8]), and are operated on by the code 26 within the function 22.

To deal with these variables 20, 21, in the new function synthesis processing as shown in the procedure S44, code 28A to convert global variables into local variables and code 28B to convert local variables into global variables are added, and the function 26 is converted into a new function 260 in which local variables are substituted for global variables. This is the source program PC of FIG. 8. To this source program PC are added code 25 declaring the substituted local variables tmp1, tmp2, tmp3 as integers; code 28A to substitute local variables for global variables; and code 28B to perform the opposite substitution. Also, the function 26 is replaced by a new function 260 rewritten using local variables. This state is represented by the source program PC in FIG. 6 as well.

As indicated by the procedure S46, the newly generated function 260 is separated from the source program PC, code 16 calling this function is added, and the source program PD is generated. The separated program module PE is then added to the source program PD. In this case also, the separated program module PE is replaced by the pseudo-function test1, and is called from the modified source program PD.

Returning to the source program evaluation procedure of FIG. 4, the source program PD, PE newly synthesized by the new function synthesis processing S32 is processed according to the procedure S30. That is, the parser is executed, the syntax of the source program PD, PE is analyzed, and a variable memory table and source program structure data are generated.

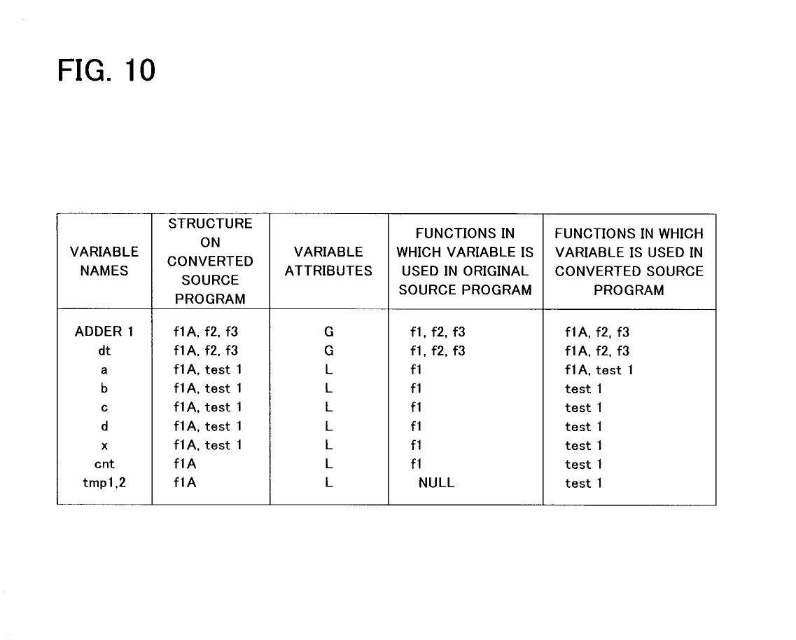

FIG. 10 shows an example of a variable memory table. This example is an example of a variable memory table for the source program PD, PE shown in FIG. 9. Variable names are indicated in the leftmost column; also shown are references indicating which functions the variable is used by in the converted source program, the variable attributes (whether global G or local L), markers indicating the functions in the original source program in which the variable is used, and markers indicating the functions in the converted source program. In this example, the global variables ADDER1 and dt are used by the functions f1, f2, f3 in the original source program (in FIGS. 6, 8 and 9, the functions func1, func2, func3), and are used by the function f1A in the converted source program (in FIGS. 6, 8 and 9, the function func1A). The local variables a, b, c, d, x are used by the function f1 in the original source program, and are used by the functions f1A and test1 in the converted source program, and the local variable cnt is used in the function f1A. The newly generated local variables tmp1, tmp2 are not used in the original source program, but are used by the function f1A in the converted source program. By means of this variable memory table, address management of the memory space for variables in the source program is performed.

The source program structure data generated by execution of the parser is data resulting by rendering the syntax of the source program into a tree structure. This data structure is well known, and so an explanation is here omitted.

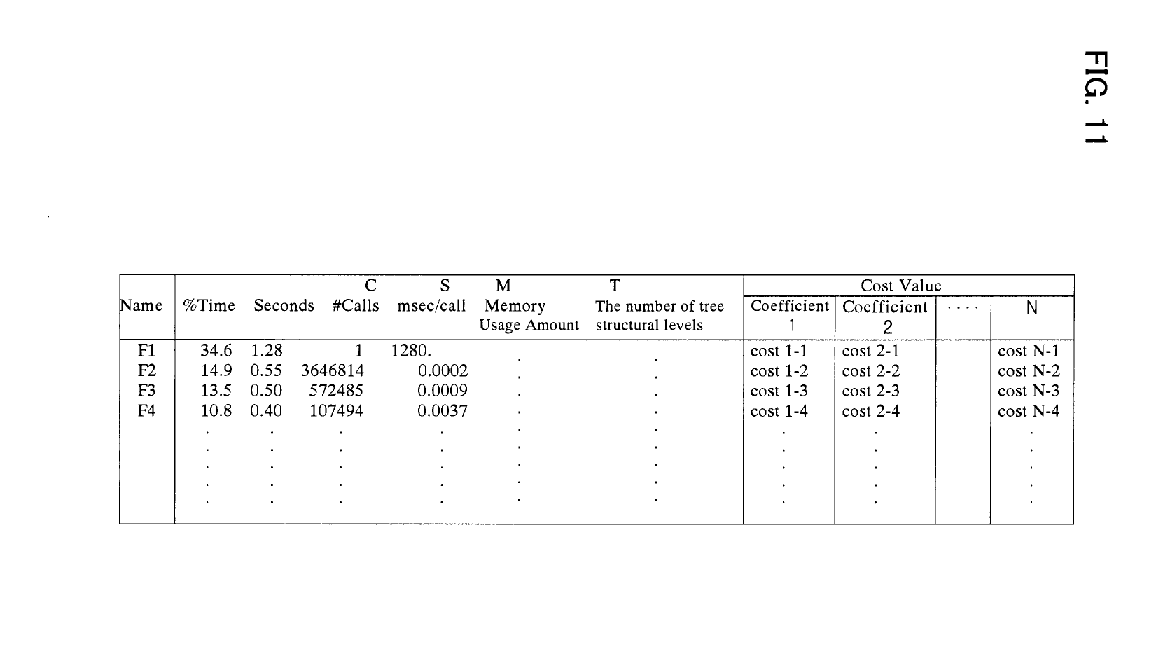

FIG. 11 shows an example of a cost table. As shown in the procedure S30, by executing the profiler, which is a tool for program analysis, indices for the cost values of each of the functions (program modules) are calculated for the source program PD, PE. Specifically, by compiling and executing the source program, the usage states of each of the functions is determined. An example of this appears in FIG. 11.

As shown in FIG. 11, through execution of the profiler, the machine time fraction % Time, actual execution time Seconds, number of function calls C, and execution time per function call S are computed for each function as indices used in cost value calculations. Also, the amount of memory usage M is computed based on the types of variables declared within functions. For example, in the case of the C language, for int, double, and float type variables, the bit length is specified as a machine-dependent parameter, and the amount of memory usage can be calculated. Also, the number of levels T of the tree structure of a function can be calculated from the program code. These indices C, S, M, and T are weighted using coefficients, and cost values are computed. For example, if the coefficients are respectively k1, k2, k3 and k4, then the cost is computed as:

Cost=k1M+k2C+k3S+k4T

These coefficients are selected according to the proportions of use of memory circuits and logic circuits within the reconfigurable hardware. Hence depending on the proportion of use of memory circuits and logic circuits, a plurality of combinations of coefficients are conceivable. Hence as shown in FIG. 11, the costs were calculated for the plurality of combinations of coefficients 1, 2, . . . , N.

Returning to the source program evaluation procedure of FIG. 4, as shown in the procedure S34, the costs of each of the functions of the modified source program PD, PE and the overall cost are computed according to the combination of the plurality of coefficients. The overall cost is calculated for each of the combinations of coefficients. A judgment is then performed as to whether the overall cost exceeds a setting determined in advance (procedure S36). If the setting is not exceeded, it cannot be expected that the efficiency of program execution will be significantly improved even if the reconfigurable hardware is substituted, and so the evaluation procedure is either reset or terminated.

If the overall cost exceeds the setting, it can be expected that the efficiency of program execution will be improved by substitution of reconfigurable hardware. Hence the combination of coefficients for which the overall cost is maximum is selected by means of procedure S38. Of the costs for each function computed using the selected combination of coefficients, the N functions having the greatest cost are selected. N is an arbitrary setting. In the examples of source programs PC, PD, and PE of FIGS. 8 and 9, the function 260 within the function func1A is selected as the function having the greatest cost value.

Returning to FIG. 2, when in procedure S10 the functions for which reconfigurable hardware is to be substituted as a result of source program evaluation are selected, a hardware module object is generated for the purpose of variable hardware generation for the selected functions (procedure S12). That is, when as shown in FIG. 6 the function test1 for substitution of reconfigurable hardware is selected by the translator, the source program PE for the function test1 is converted into a hardware module object PH. The hardware module object is binary code which can be supplied to a reconfigurable LSI device; by supplying this code, dedicated hardware which executes the processing of the source program PE is configured within the reconfigurable LSI device.

Before being called by the calling function “x=test1” within the modified source program PF, the virtual hardware module PG is added. This virtual hardware module PG is a program module which generates an interface between addresses provided for variables at the time of execution of the source program PF, and addresses in the hardware configured by the hardware code module object PH. This interface is generated by referencing the variable memory table shown in FIG. 10. Hence the translator automatically generates a program module PG which generates this interface.

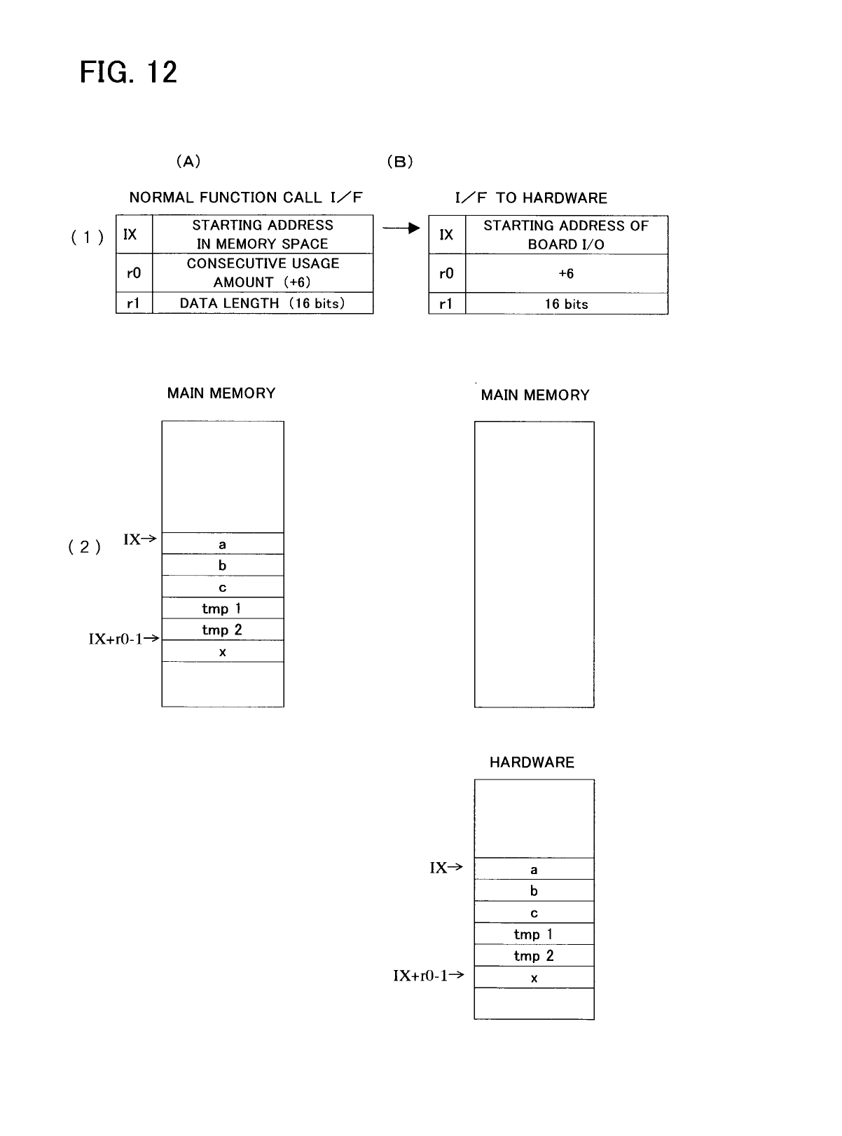

FIG. 12 shows the interface for normal function calls and the interface to the hardware. In the figure, (A) shows the interface for normal function calls; (1) is the table used to set addresses in the memory space, and (2) is the area for addresses set by this means. That is, for the normal function call “x=test1”, the compiler refers to the variable memory table, and allocates to the six variables a, c, b, tmp1, tmp2, x of this function the addresses in main memory IX to IX+r0-1.

However, in this aspect hardware is substituted for the function test1, so that if the variables are left set in the above addresses, variables cannot be passed to the hardware appropriately. By executing the virtual hardware code module PG, as shown in (B) of FIG. 12, the table in (1) is rewritten. As a result, the addresses of the six variables in the address space of (2) are modified from addresses in main memory to the hardware addresses IX to IX+r0-1.

In this way, the variable area allocated when using the normal operating system to execute the source program PF is replaced with a variable area in the newly configured reconfigurable hardware by the virtual hardware code module PG. By this means, even if a portion of the functions of the source program is removed and replaced with hardware, the exchange of variable data between the source program PF and the hardware can be guaranteed.

Thus by means of the translator, with the pseudo-function test1 used as the program PE to be replaced by hardware and the function call 16 calling this pseudo-function included in the modified source program PF, as shown in FIG. 6, the virtual hardware code module PG which replaces the variable address area with a hardware address area is added to the code called by the function call 16. And, the source program PE to be replaced is converted into the hardware code module object PH.

Next, the scheduler executes the modified source program PF, PG. Prior to this execution, the hardware code module is loaded into the reconfigurable LSI device, which is configured as dedicated hardware to execute the program PE, as shown in FIG. 3 (procedure S20). After this dedicated hardware is configured, the modified source program PF, PG is executed (procedure S22).

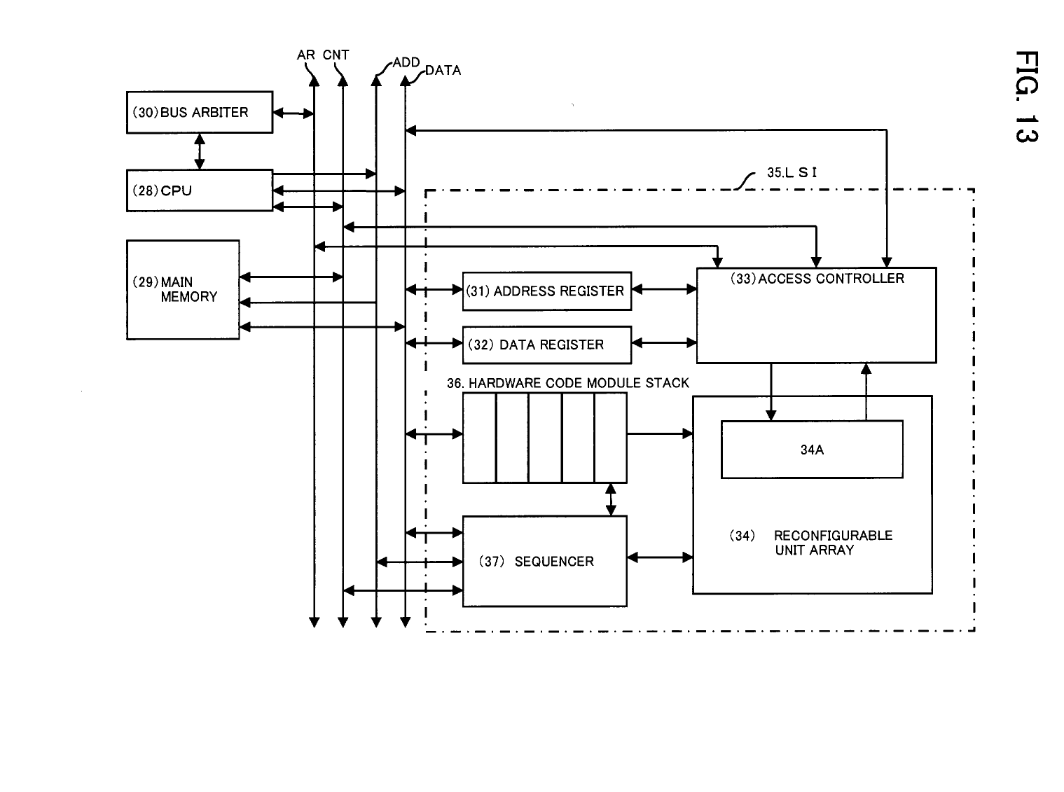

FIG. 13 is a diagram of the configuration of a computer system having an LSI device as reconfigurable hardware. In the computer system shown in FIG. 13, the CPU 28, main memory 29, bus arbiter 30, and LSI device 35 as reconfigurable hardware are connected via a bus comprising bus arbiter signals AR, control signals CNT, an address bus ADD, and a data bus DATA.

Within the main memory 29 are stored the OS, the original source program for processing, the modified source program PF, PG, and the hardware code module object PH. In addition, the program which performs processing of the source program of this aspect is stored. The OS, the original source program, and the processing program are loaded into main memory 29 from an external hard disk via a memory controller, not shown. As indicated in FIG. 6, the original source program is replaced by the translator with the modified source program PF, PG and with the hardware code module object PH.

The reconfigurable LSI device 35 has within an address register 31 and data register 32; an access controller 33 which controls access via the bus; a reconfigurable unit array 34; a hard code module stack 36 into which is loaded the hardware code module object PH to configure the reconfigurable array 34; and a sequencer 37.

As shown in FIG. 3, the scheduler loads the hardware code module object PH in main memory 29 into the hardware code module stack 36 in the LSI device 35 via the data bus DATA. When using the data bus, bus use privileges are adjusted by the bus arbiter 30. The sequencer 37 dynamically supplies the hardware code module object PH stored in the hard code module stack 36 to the reconfigurable unit array 34 with appropriate timing, and configures a dedicated hardware circuit to execute the source program PE within the array 34. The reconfigurable unit array 34 comprises, for example, a programmable gate array (FPGA), and by providing the hardware code module object PH within the stack 36, a corresponding dedicated circuit is configured.

The access controller 33 exercises control when the dedicated circuit configured within the reconfigurable unit array 34 accesses an address in main memory 29, and exercises control when the CPU 28 writes and reads variable data in a function call of the substituted program PE.

When the modified source program PF is executed, the pseudo-function “x=test1” is read. As a result of this function call, the virtual hardware code module PG is executed by the CPU. In this function call, addresses are allocated to variables, as in (A) of FIG. 12. And through execution of the virtual hardware code module PG, variable addresses are replaced by addresses in the hardware 35, as indicated in (B) of FIG. 12. Hence the CPU regards the above substituted addresses as the variable addresses for the function call.

As a result, when the CPU executes the modified source program PF, data read and write requests are issued for the addresses allocated in hardware 35. The access controller 33 controls these read and write operations. As explained above, the bus arbiter 30 is used for arbitration of bus use.

Conversely, there are cases in which the configured hardware 34 issues a read or write request, specifying an address in main memory 29. In this case also, the address in main memory 29 is provided to the address register 31, and after bus arbitration by the bus arbiter 30, the necessary data is read from or written to main memory. The data register 32 is used for this.

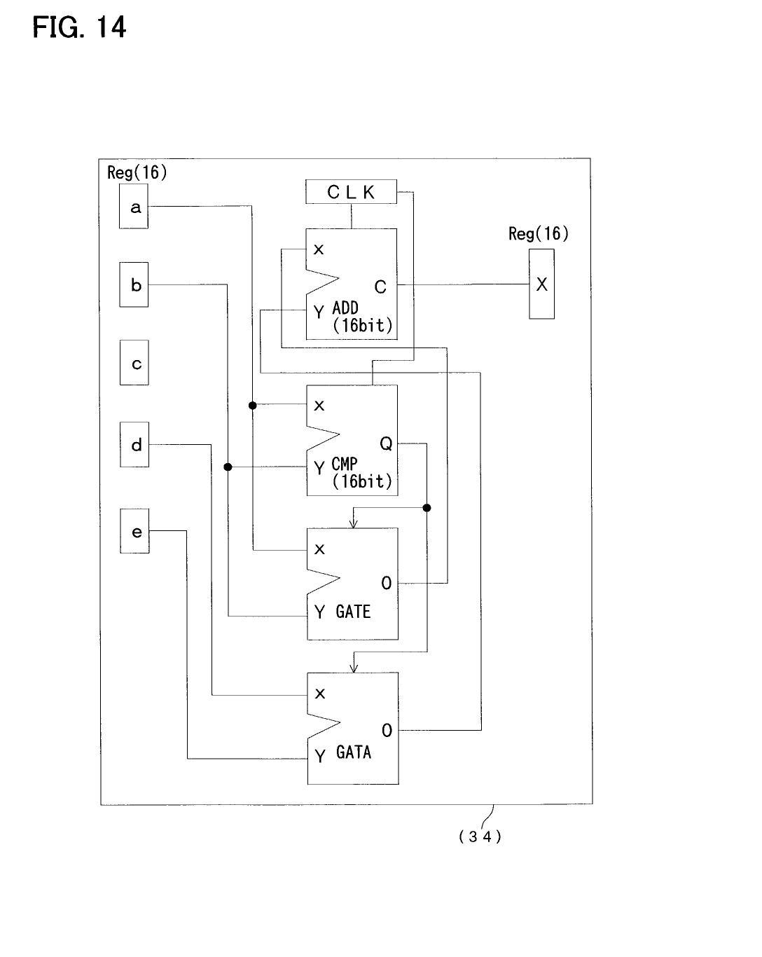

FIG. 14 is an example of hardware configured using reconfigurable hardware. This example is of hardware corresponding to the program PE for replacement in FIG. 9. The program PE for replacement in FIG. 9 has as variables a, b, d, e, and x. Hence registers a, b, d, e, x are provided corresponding to these variables. Further, together with the clock generator CLK, an adder ADD which performs the operation c=x+y, a comparator CMP which compares x and y and, if equal, generates the output EQ, and a selection gate GATE which outputs x or y according to the output EQ from the comparator, are provided. As a result of processing by this dedicated circuit, the result x is computed in the register x. As shown in FIG. 14, the dedicated circuit can be dynamically reconfigured by using the FPGA.

As explained above, the program processing method of this aspect analyzes the original source program, selects a function the replacement of which by a dedicated hardware circuit would be suitable for improving overall processing efficiency, and generates binary code in order to replace the function by a dedicated hardware circuit based on reconfigurable hardware. At the same time, a virtual hardware code module object is generated to modify the interface for variables of the dedicated hardware circuit and the modified source program. By loading this binary code into the reconfigurable hardware to configure a dedicated hardware circuit, and having the computer process the modified source program, the replaced function can be processed by the dedicated hardware circuit, and the processing efficiency of the source program can be improved.

### INDUSTRIAL APPLICABILITY

In this invention, a source program to be processed is analyzed; a program module is selected which, if replaced by dedicated hardware, would result in higher processing efficiency; modification of the source program necessary for this is performed; and a program which generates an interface to the dedicated hardware circuit is created. Hence by subsequently executing the modified source program, the program module for replacement is processed using the dedicated hardware circuit, and other portions of the source program are processed as usual using computer resources. As a result, the overall processing efficiency can be improved.

1. A program processing method for processing a source program to be executed by a computer, the method comprising:
an evaluation process, which analyzes said source program, calculates costs for using resources of said computer in units of prescribed program modules comprised by the source program, and selects a program module for which said usage cost value is high;
an editing process, which generates a hardware module object to configure dynamically reconfigurable hardware in order to perform processing of said selected program module, and modifies said source program by adding a pseudo-function which calls the selected program module; and,
an execution process, which executes said modified source program by means of hardware configured according to said hardware module object and by means of said computer.

2. The program processing method according to claim 1, wherein said evaluation process comprises a new function synthesis process which, when said source program has a global variable, generates a local variable corresponding to said global variable, replaces the global variable with the local variable in said program module; and said evaluation process analyzes the new source program generated by said new function synthesis process to calculate usage costs.

3. The program processing method according to claim 1, wherein said evaluation process further comprises a new function synthesis process which, when said source program has a global array variable or a global variable pointer, generates a local variable corresponding to said global variable, replaces the global variable with the local variable in said program module, and adds code to convert between said global variable and local variable; and said evaluation process analyzes the source program generated by said new function synthesis process to calculate usage costs.

4. The program processing method according to claim 1, wherein, in said evaluation process, said computer resource usage costs are computed by weighting of, at least, the memory usage amount for a program module, the number of times the program module is called, the processing time per call of the program module, and the number of tree structure levels of the program module, according to a prescribed combination of coefficients.

5. The program processing method according to claim 4, wherein said computer resource usage costs are computed for each of a plurality of combinations of said coefficients, and said program module is selected based on usage costs in said program module units according to coefficients corresponding to the optimum overall cost among the overall costs of the source program computed according to the plurality of computed usage costs.

6. The program processing method according to claim 1, wherein said editing process comprises a process which generates a virtual hardware code module, which associates input/output addresses of said hardware with address space allocated to the variables of said pseudo-function, and adds the virtual hardware code module thus generated to said modified source program.

7. The program processing method according to claim 1, wherein, in said execution process, a plurality of said hardware module objects are loaded into said hardware and recorded, that while executing said modified source program, prior to executing said pseudo-function, said hardware is reconfigured according to the hardware module object corresponding to the pseudo-function.

8. Recording media, on which is recorded a program causing a computer to execute the program processing method according to any of claims 1 through 7.
